(19) United States
(12) Patent Application Publication
(10) Pub. No.: US 2013/0070569 A1
(43) Pub. Date: Mar. 21, 2013

(54) OSCILLATORS SYNCHRONISED BY AN INTERMITTENT ESCAPEMENT

(71) Applicants: Davide SARCHI, Renens (CH); Nakis KARAPATIS, Premier (CH); Thierry HESSLER, St-Aubin (CH); Jean-Luc HELFER, Bienne (CH)

(72) Inventors: Davide SARCHI, Renens (CH); Nakis KARAPATIS, Premier (CH); Thierry HESSLER, St-Aubin (CH); Jean-Luc HELFER, Bienne (CH)

(73) Assignee: The Swatch Group Research and Development Ltd., Marin (CH)

(21) Appl. No.: 13/610,024

(22) Filed: Sep. 11, 2012

(30) Foreign Application Priority Data
Sep. 15, 2011 (EP) 11181512.2

(51) Int. Cl. G04B 15/00

(52) U.S. Cl. 368/62; 368/125; 368/127

(57) ABSTRACT

The invention relates to a timepiece (1) comprising a first resonator (R₁) oscillating at a first frequency (f₁) and connected by a main gear train (T₂) to a main energy source (B₂) via a main escapement (D₂). According to the invention, the timepiece comprises a second resonator (R₂) oscillating at a second frequency (f₂) which is lower than the first frequency and cooperating with the main escapement (D₂) in order to synchronise maintenance of the first resonator (R₁) to said second frequency (f₂).

The invention concerns the field of coupled oscillators.

This application claims priority from European Patent Application No. 11181512.2 filed Sep. 15, 2011, the entire disclosure of which is incorporated herein by reference.

### FIELD OF THE INVENTION

The invention relates to a timepiece comprising oscillators intermittently synchronised by an escapement.

### BACKGROUND OF THE INVENTION

Generally, the regulating member of a watch is formed by a harmonic, damped, almost isochronous resonator, whose oscillation is maintained by an escapement system, which transfers the energy to the resonator at each oscillation vibration (lever escapement) or each oscillation period (detent escapement).

There are several problems concerning maintenance of the oscillation of the regulating member, also called the resonator. Thus, the transfer of energy to the resonator disturbs its frequency (and therefore the rate of the watch) in every case where the transfer is not symmetrical relative to the point of rest of the resonator. Further, the energy spent by the escapement per vibration (or per period) and the resonator frequency determine the power reserve of the watch, which is thus limited.

Moreover, since the amplitude of the oscillator is limited by geometrical reasons, in order to increase the energy of the oscillator (and therefore its stability against external disturbances) its elastic constant must be increased, which may mean that it is impossible to start up high frequency oscillators.

Finally, the mean efficiency of the escapement and fluctuations in efficiency are affected, amongst other things, by the acceleration of the escapement components. Thus, the more quickly the resonator recovers, the higher the efficiency and time constant will be. Hence, for very high frequency resonators, losses must necessarily be increased (and the power reserve decreased) and/or fluctuations in efficiency must be increased.

### SUMMARY OF THE INVENTION

It is an object of the present invention to overcome all or part of the aforecited drawbacks by proposing a timepiece whose frequency (improved display resolution) and mechanical energy (improved stability and precision) are increased, and wherein the oscillation maintenance and power reserve are also improved.

The invention therefore relates to a timepiece comprising a first resonator oscillating at a first frequency and connected by a main gear train to a main energy source via a main escapement, a second resonator oscillating at a second frequency, which is a product of the first frequency according to a factor which is a rational number, characterized in that the second resonator also cooperates with the main escapement in order to release the main escapement to maintain the first resonator only when said second resonator oscillates.

It is clear that the invention enables the maintenance frequency of a resonator to be reduced below its frequency. The invention also ensures that a high frequency movement can auto-start while preserving its power reserve, particularly by improving the efficiency of the escapement functions. Finally, the invention substantially reduces rate errors generated by disturbances outside the watch.

In accordance with other advantageous features of the invention:
according to a first embodiment, the main escapement is a detent escapement and comprises a single escape wheel cooperating with a first detent spring controlled by the first resonator and a second detent controlled by the second resonator;
according to a second embodiment, the main escapement is a detent escapement and comprises a first escape wheel cooperating with a first detent controlled by the first resonator and a second escape wheel cooperating with a second detent controlled by the second resonator, the first and second escape wheels being meshed with each other;
according to a variant of the embodiments, the second resonator is also connected to a secondary gear train to a secondary energy source via a second escapement;
the second escapement is a Swiss lever escapement;
the variant includes a time display device comprising a display power source connected to a gear train for the display secured to a distribution mechanism formed by a detent and controlled by the main resonator or a time display device connected to the main gear train;
according to a particular alternative of the variant, the timepiece includes a means of selectively locking the main escapement in order to measure a time using the first resonator by releasing said selective locking means;
the particular alternative includes a device for displaying said measured time comprising a display energy source connected to a gear train for the display secured to a distribution mechanism controlled by the main resonator and a time display device connected to the secondary gear train.

### BRIEF DESCRIPTION OF THE DRAWINGS

Other features and advantages will appear clearly from the following description, given by way of non-limiting illustration, with reference to the annexed drawings, in which:

FIG. 1 is a schematic diagram of the elements of a timepiece according to the invention;

FIG. 2 is a schematic diagram of the main escapement according to a first embodiment;

FIG. 3 is a schematic diagram of the main escapement according to a second embodiment;

FIG. 4 is a partial enlarged diagram of FIG. 3;

FIG. 5 is a graph showing the synchronisation of the resonators according to the invention;

FIGS. 6 and 7 are graphs showing the low shock dependence of a timepiece according to the invention following synchronisation of its resonators as regards their amplitude and rate variation respectively.

### DETAILED DESCRIPTION OF PREFERRED EMBODIMENTS

As explained above, it is an object of the invention to integrate, in a mechanical wristwatch, a high frequency resonator (e.g. 10 Hz or 50 Hz or more) whose oscillation maintenance is synchronised by a low frequency resonator (e.g. 1 Hz or 2 Hz) in order to maintain the resonator over a period higher than its frequency.

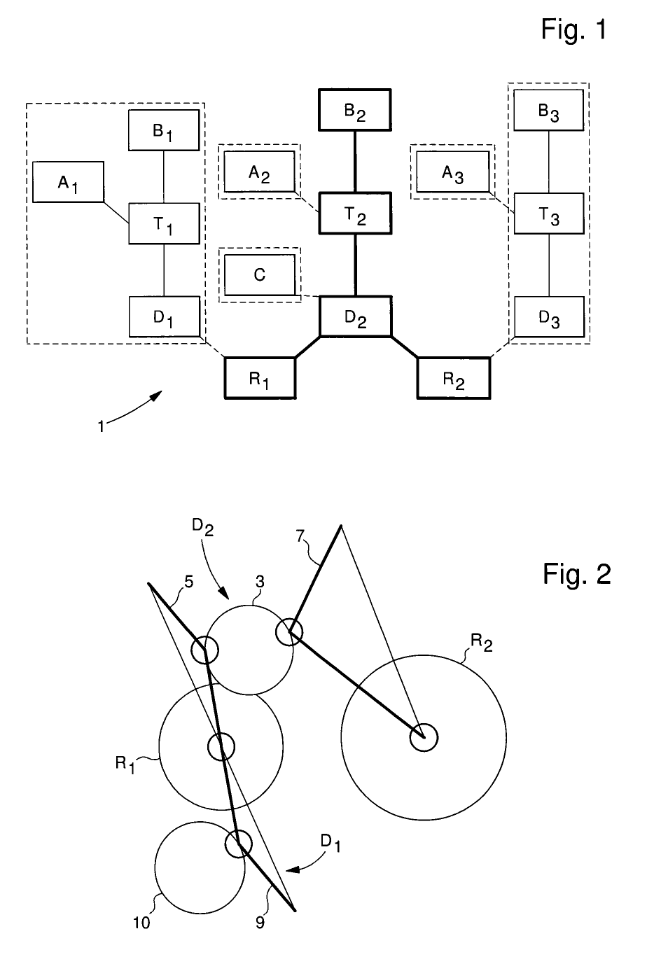

In an example embodiment illustrated in FIG. 1, timepiece 1 therefore includes a first resonator R₁ oscillating at a first frequency f₁ and connected by a main gear train T₂ to a main energy source B₂ via a main escapement D₂. Advantageously, timepiece 1 further comprises a second resonator R₂ oscillating at a second frequency f₂ which is lower than the first frequency and cooperating with the same main escapement D₂ in order to synchronise maintenance of the first resonator R₁ to said second frequency f₂.

Preferably, according to the invention, the second frequency f₂ is a fraction of the first frequency (f₂=f₁/N or f₂=f₁/2N where N is an integer number greater than 1). It is thus clear that main resonator R₁ is maintained solely with the period of the secondary resonator.

However, the factor may also be a rational number N′ if the gear ratio Rᵢ is different between each oscillator. Indeed, in this variant, the frequencies on the wheel which secures the two escapements must be linked by a multiple integer number. However, the gear ratio can arbitrarily and independently subdivide the frequency of the oscillators. The oscillator frequencies may then not be linked by an integer number, but by a rational number (f₂=f₁/N′ where N′ is equal to N*R₁/R₂ where N is an integer number greater than 1).

This configuration advantageously means that a basic movement (or chronograph movement) can be made with a high resolution (for example 1/20th of a second or 1/100th of a second). It also increases the precision and shock resistance of the main resonator and increases the power reserve while guaranteeing that even a very high frequency movement, for example 50 Hz, can auto-start. Finally, this configuration allows low amplitude resonators to be maintained and the display train and/or maintenance train to be partially or totally omitted.

According to a first embodiment illustrated in FIG. 2, main escapement D₂ is a detent escapement and comprises a single escape wheel 3 cooperating with a first detent 5, controlled by first resonator R₁ and a second detent 7 controlled by the second resonator R₂.

By way of example, it can be assumed that wheel 3 is free if the two resonators R₁ and R₂ are situated around the point of rest in the angular interval (−20°, +20°). To ensure that the main resonator R₁ is maintained, if the two resonators have a considerably different phase, i.e. they pass the point of rest at two different moments, detent 7 of secondary resonator R₂ may be devised to increase the angular interval in which main escapement D₂ is released by secondary resonator R₂. It is thus clear that detent 7 of secondary resonator R₂ preferably includes release over a larger angular interval than the angle of detent 5 at which main resonator R₁ releases wheel 3.

Consequently, as soon as the detent is released, since the braking force acting on the oscillator is applied very close to the centre of rotation of the oscillator, the resulting perturbation torque is very low, i.e. the angle of release for secondary resonator R₂ may thus be considerably increased without affecting the rate.

If, after a shock, the phase difference of the resonators is too great and oscillation cannot be maintained, it is clear that the increasing or decreasing isochronism curve of main resonator R₁ allows the phase to be made up between the two resonators after a few oscillations. In fact, main resonator R₁ will lose amplitude until phasing is re-established between the oscillation of secondary resonator R₂ and one of the N oscillations of main resonator R₁. It is thus clear that the additional rate error on the display will be less than or equal to one period of main resonator R₁, which means that it will become smaller the higher the frequency f₁ becomes.

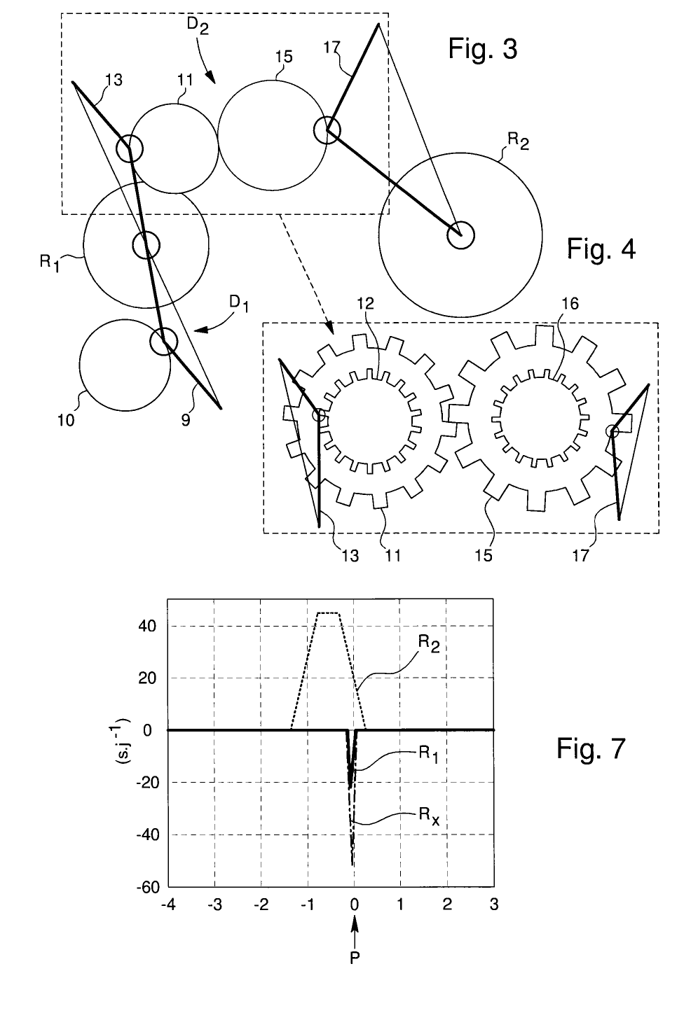

According to a second embodiment illustrated in FIGS. 3 and 4, main escapement D₂ is a detent escapement and comprises a first escape wheel 11 cooperating with a first detent 13 controlled by the first resonator R₁ and a second escape wheel 15 cooperating with a second detent 17 controlled by the second resonator R₂, the first and second escape wheels 11, 15 being meshed with each other. It is thus clear that, structurally, the same advantages are obtained as for the first embodiment, particularly during intrinsic or shock-induced phase differences.

However, compared to the first embodiment, it is noted that resonators R₁ and R₂ release, by detent, two different wheels 11 and 15, which mesh (in parallel or in series) with the main gear train T₂. Once released, wheel 15 is not locked again until wheel 11, and therefore escapement D₂, is released. In this case, escapement D₂ is released at each oscillation period (or vibration) of main resonator R₁ and at each oscillation of secondary resonator R₂, maintenance is guaranteed independently of the phase difference of resonators R₁ and R₂.

The example illustrated in FIG. 4 shows the meshing of wheels 11, 12, 15, 16 and detents 13, 17. Escape wheel 15 is released by detent 17 at top toothing 16 on each oscillation of secondary resonator R₂ and describes a small angle before being locked again by top toothing 16 via detent spring 17 of secondary resonator R₂. However, during the motion of wheel 15, wheel 11 remains locked on top toothing 12 by detent 13 of main resonator R₁.

When main resonator R₁ passes, wheel 11 is released by detent 13 at top toothing 12 and allows main resonator R₁ to be maintained, before being locked again by detent spring 13 on top toothing 12 and/or by wheel 15 which then plays a part comparable to a stopping device. Of course, wheel 11 remains locked when main resonator R₁ passes if secondary resonator R₂ has not previously released wheel 15.

It is thus clear that the two embodiments of main escapement D₂ provide substantially the same advantages and use a single main escapement D₂ for the two resonators R₁ and R₂, i.e. the resonators are maintained using the same main energy source B₂ by main escapement D₂.

According to a variant of the above two embodiments, the second resonator R₂ is also connected to a secondary gear train T₃ to a secondary energy source B₃ via a second escapement D₃. Indeed, if it becomes necessary to maintain secondary resonator R₂ outside main escapement D₂, a second escapement D₃ preferably a Swiss lever escapement, maintains secondary resonator R₂. Thus, at each vibration of secondary resonator R₂, the latter is powered by secondary energy source B₃ (or, alternatively, by the main energy source B₂ by means of a gear) via the secondary gear train T₃.

A particular alternative of this variant which requires maintaining secondary resonator R₂ outside main escapement D₂ is shown in FIG. 1. In this alternative, timepiece 1 includes a means C of selectively locking main escapement D₂ in order to measure a time using first resonator R₁ by releasing said selective locking means. It is thus clear that, structurally, main resonator R₁ becomes a chronograph device, i.e. it only operates during measuring periods and secondary resonator R₂ is the basic movement, i.e. it is permanently in operation. Of course, in this alternative, the secondary resonator R₂ preferably has good isochronism to allow proper display after the release of said selective locking means C.

The advantages of the invention have been quantified from the variant of the first embodiment of main escapement D₂. If the elastic constant of the resonator is kⱼ and its inertia mⱼ its oscillation frequency is:

fⱼ=\sqrt{kⱼ}/mⱼ/2π (1)

For a stationary amplitude Aⱼ, the mechanical energy of the resonator j is:

Eⱼ=1/2kⱼAⱼ² (2)

The resonator energy loss j at each oscillation is:

$$Δ {E}_{j} = \frac{π {E}_{j}}{2 {Q}_{j}} \qquad ( 3 )$$

and depends on the resonator quality factor Qⱼ (which, for viscous friction, increases with frequency).

The escapement must supply the same quantity of energy. If the torque applied to the resonator is constant over a given angle θⱼ, the maintenance energy is:

$${E}_{ech} = {C}_{ech} {θ}_{j} = Δ {E}_{j} = \frac{π {E}_{j}}{2 {Q}_{j}} \qquad ( 4 )$$

Increasing the resonator frequency increases the quality factor a, which promotes improved timing. If the resonator energy is constant, losses decrease and the maintenance energy also decreases. Since the angle of energy transmission cannot be decreased indefinitely, the maintenance torque must be decreased.

Moreover, the condition necessary for starting is that the maintenance torque exceeds the elastic return torque of the resonator at the exit angle thereof.

C_{cch}>kⱼθⱼ/2 (5)

This means that the maintenance torque cannot be decreased indefinitely while maintaining the auto-start property of the resonator, and, at the same time, without decreasing the mechanical energy of the resonator which decreases its stability against external disturbance.

It must also be realised that the increase in frequency and decrease in maintenance torque results in a higher resonator speed (v=2π f A, (6)) at the point of rest, i.e. at the moment when maintenance does not cause rate errors, while the acceleration of the escape wheel sets is lower. It is thus observed that the escapement efficiency drops because the escapement is unable to catch up with the resonator. It is thus clear that the escape wheel sets must catch up with the resonator speed during the time available for maintenance:

C_{ech}/m_{ech}>v/dt_{ech}=v²/θⱼ (7)

where m_{ech} is i the equivalent inertia of the escapement.

Finally, if the frequency and energy of the resonator are increased, the power reserve will necessarily decrease, since the escapement must maintain the resonator more often and with more energy each time.

Thus, quantitatively, for an ordinary resonator with a frequency f equal to 10 Hz, an inertia m equal to 2 mg·cm², an elastic coefficient k equal to 0.79 μNm·rad⁻¹ and a quality factor Q equal to 600, the maintenance energy E_{ech} is substantially equal to 25 nJ. According to relation (4), therefore, maintenance torque C_{ech} is substantially equal to 28 nNm, for a maintenance angle θⱼ of 50°. The system does not auto-start because the term k.θⱼ/2 is greater than the maintenance torque E_{ech} according to relation (5).

On the other hand, the time available for maintenance, which corresponds to the resonator passing from the point of rest, is reduced to dt_{ech} equal to 40°, i.e., according to relation (6), a time of 2.3 milliseconds for an amplitude A equal to 280°. To achieve sufficient acceleration of the escape wheel sets with such a low maintenance torque, according to relation (7), the inertia of the maintenance wheel sets has to be considerably reduced to an equivalent inertia of substantially 2.10⁻³ mg·cm².

If a resonator of the same type is maintained by an escapement D₂ according to the invention, at a frequency f₂ equal to 1 Hz, the lost energy to be compensated for at each maintenance function is 20 times higher. At parity, with a maintenance angle θⱼ equal to 50°, the maintenance torque C_{ech} is 20 times higher, i.e. approximately 0.7 μNm, and the self-start system accords with relation (5).

Likewise, the acceleration of the maintenance wheel sets is increased 20 fold and efficiency can be freely optimised, the only constraint being geometrical and tribological and no longer dynamic and related to the energy balance. Consequently, since efficiency is improved, the power reserve is necessarily improved.

To demonstrate the advantages of the timepiece of the invention, the coupled movement equations were resolved numerically. A secondary resonator R₂ with an inertia m₂ equal to 10 mg·cm², a frequency f₂ equal à 1 Hz and a quality factor Q₂ equal to 150 was considered. Moreover, the main resonator R₁ has a mechanical energy equal to 9.6 μJ, whereas secondary resonator R₂ has an energy equal to 0.5 μJ.

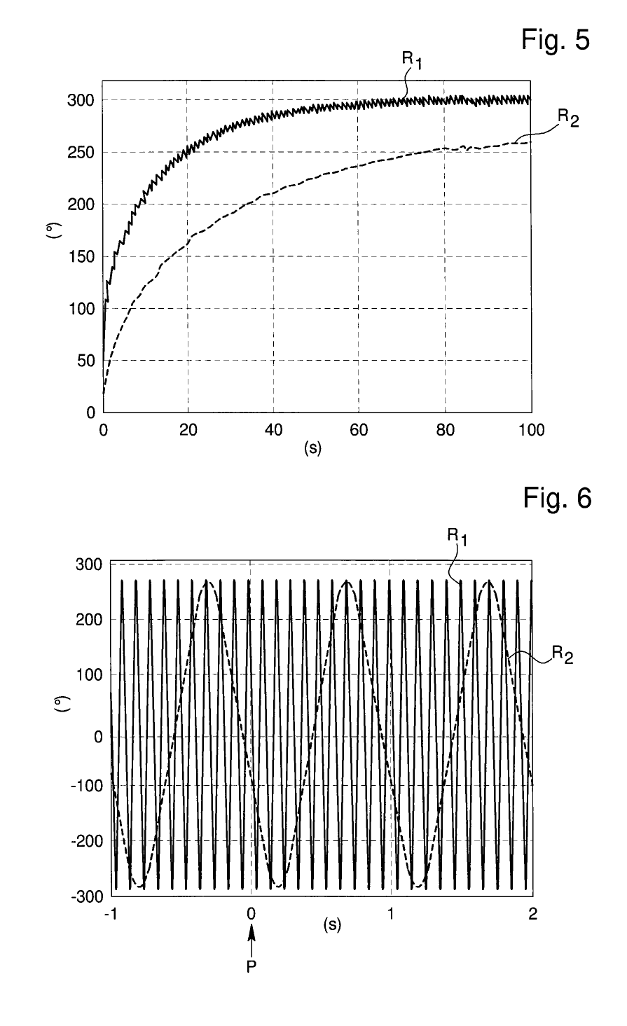

FIG. 5 shows a simulation of the starting of the two resonators R₁ and R₂. The main high frequency resonator R₁ returns to its stationary frequency after approximately 50 seconds. It is noted that low frequency secondary resonator R₂ returns to its stationary amplitude more slowly. However, this has no significant effect since the function of regulating the transfer of energy to main resonator R₁ is fully operational as soon as secondary resonator R₂ recovers several tens of degrees. Consequently, the timepiece succeeds in auto-starting and is stabilised on a substantially stationary amplitude for main resonator R₁ even if it is equal to or higher than 10 Hz.

FIG. 6 shows a simulation of the disturbance P made to the timepiece when the two resonators R₁ and R₂ are stabilised. Disturbance P, equal to 0.1 μJ, occurs at moment t=0 by an impulsed angular acceleration of 50 rad.s⁻² with a Gaussian shape and a width of 20 milliseconds. It is to be noted that resonators R₁ and R₂ do not experience any significant phase difference prior to and after disturbance P.

Moreover, FIG. 7 shows a simulation of the same disturbance P made to the timepiece when the two resonators R₁ and R₂ are stabilised. This time, it is the rate of each resonator that is measured relative to that of a single resonator Rₓ. It can be seen that the presence of an escapement D₂ according to the invention does not amplify the rate error compared to the single resonator Rₓ. It is therefore clear that the direct effect on main resonator R₁ and the indirect effect of maintaining main resonator R₁ on resonator R₂ partially compensate for each other.

Consequently, the response of a timepiece according to the invention to a given disturbance P is similar, or even better than the response of an equivalent single resonator Rₓ, i.e. with the same energy Eₓ, same frequency fₓ et same amplitude A. Further, secondary resonator R₂ advantageously forms an anti-tripping system for the maintenance function, particularly by preventing rate errors linked to dual maintenance.

Depending upon the embodiment, variant and/or alternative selected above, timepiece 1 according to the invention proposes three types of display device A₁, A₂ and/or A₃.

A first display type includes a display device A₁ comprising a display energy source B₁ connected to a gear train for the display T₁ secured to a distribution mechanism D₁ controlled by main resonator R₁. Preferably according to the invention, the distribution mechanism D₁ is formed by a detent 9 controlled by main resonator R₁ so as to release, at each period or vibration of main resonator R₁, wheel 10 connected to gear train T₁ without providing any additional maintenance torque to first resonator R₁.

It is thus clear that display device A₁ takes advantage of the high frequency of main resonator R₁ by displaying the movement, for example of wheel 10, i.e. with improved resolution such as, for example, up to 1/20th of a second or up to 1/100th of a second. Consequently, in the case of the two embodiments and/or the variant explained above, display device A₁ can display the time with improved resolution. Further, in the case of the alternative explained above, display device A₁ can display the measured time with improved resolution.

A second display type includes a time display device A₂ connected to secondary gear train T₂. It is therefore clear that the display occurs at the same time that main resonator R₁ is being maintained. In this case, the high frequency is not used to improve resolution but to improve stability. It is also clear that this configuration forms a very efficient anti-tripping system for detent escapement D₂, regardless of the embodiment used.

Finally, a third display type includes a time display device A₃ connected to secondary gear train T₃. This third type is entirely dedicated to the above alternative in which main resonator R₁ is used solely for measuring a time. Indeed, since secondary resonator R₂ is the only one permanently operating, the time display can only be performed using secondary gear train T₃.

In light of the above explanations, it is clear that the invention reduces the maintenance frequency of a resonator to below its frequency. The invention also ensures that a high frequency movement can auto-start while preserving its power reserve, particularly by improving the efficiency of the escapement functions. Finally, the invention substantially reduces rate errors generated by disturbances outside the watch.

Of course, this invention is not limited to the illustrated example but is capable of various variants and alterations that will appear to those skilled in the art. In particular, other types of resonators and/or escapements can be envisaged without departing from the scope of the invention. By way of example, some mechanical components could advantageously be replaced and/or assisted by magnetic components.

Finally, the timepiece may comprise a single energy source, i.e. a single energy source fitted with gears may respectively form the energy sources B₁ and/or B₂ and/or B₃ described above.

What is claimed is:

1. A timepiece comprising a first resonator oscillating at a first frequency and connected by a main gear train to a main energy source via a main escapement, a second resonator oscillating at a second frequency, which is a product of the first frequency according to a factor which is a rational number, wherein the second resonator also cooperates with the main escapement to release the main escapement in order to maintain the first resonator only when said second resonator oscillates.

2. The timepiece according to claim 1, wherein the main escapement is a detent escapement and comprises a single escape wheel cooperating with a first detent, controlled by first resonator and a second detent controlled by the second resonator.

3. The timepiece according to claim 1, wherein the main escapement is a detent escapement and comprises a first escape wheel cooperating with a first detent controlled by the first resonator and a second escape wheel cooperating with a second detent controlled by the second resonator, the first and second escape wheels being meshed with each other.

4. The timepiece according to claim 1, wherein the second resonator is also connected by a secondary gear train to a secondary energy source via a second escapement.

5. The timepiece according to claim 4, wherein the second escapement is a Swiss lever escapement.

6. The timepiece according to claim 1, wherein it includes a time display device comprising a display energy source connected to a gear train for the display secured to a distribution mechanism formed by a detent controlled by the main resonator.

7. The timepiece according to claim 1, wherein it includes a time display device connected to the main gear train.

8. The timepiece according to claim 4, wherein it includes a means of selectively locking the main escapement in order to measure a time using the first resonator by releasing said selective locking means.

9. The timepiece according to claim 8, wherein it includes a device for displaying said measured time, comprising a display energy source connected to a gear train for the display secured to a distribution mechanism controlled by the main resonator.

10. The timepiece according to claim 8, wherein it includes a time display device connected to the secondary gear train.

11. The timepiece according to claim 1, wherein it includes a single energy source.
